(19) United States
(12) Patent Application Publication
(10) Pub. No.: US 2016/0218664 A1
(43) Pub. Date: Jul. 28, 2016

(54) MODULE MOUNTING

(71) Applicant: SMARTVOLT AG, Niederönz (CH)

(72) Inventor: Kilian Wehrli, Ipsach (CH)

(73) Assignee: SMARTVOLT AG, Niederönz (CH)

(21) Appl. No.: 14/916,149

(22) PCT Filed: Aug. 28, 2014
(86) PCT No.: PCT/EP2014/068310

§ 371 Date: Mar. 2, 2016

(30) Foreign Application Priority Data
Sep. 2, 2013 (CH) 1495/13
Dec. 20, 2013 (EP) 13198825.5

(51) Int. Cl. H02S 30/20

(52) U.S. Cl. CPC H02S 30/20

(57) ABSTRACT

A module mounting and a collector module system are described. The module mounting and the collector module system have a plurality of collector modules mounted on the module mounting, having at least two support units each with at least two lateral supports. The lateral supports can receive between them at least one collector module, and the lateral supports of adjacent support units are connected together in an articulated way by means of first hinges. Provided in an articulated way at each lateral support is at least one elongated connecting element. At least one of two adjacent connecting elements is connected by second hinges which differ from the first hinges. Two adjacent connecting elements of adjacent lateral supports are connected together in an articulated way by third hinges such that the module mounting is foldable.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### RELATED APPLICATION INFORMATION

N/A

### BACKGROUND

1. Field

The present invention relates to a module mounting for a plurality of collector modules, such as solar modules or heat storage modules, which are disposed in a row and are aligned at a particular angle.

2. Description of the Related Art

Known from the state of the art are various mounting systems for collector modules in which individual modules are mounted in a row behind one another and are supposed to be aligned as optimally as possible in direction of the sun. Usually used for this purpose is an elongated beam or a track or also two beams or tracks disposed parallel, which are mounted on a substrate, such as a roof or a wall. Then the individual collector modules are fixed individually on the beam or respectively track with the aid of mountings or support frames. The mountings can thereby have shapes matching particular installation angles of the modules so that modules disposed behind one another each have the same installation angle. Such a mounting is time-consuming and most of the mounting work must be carried out on site.

Known from EP 2402679, for example, is a mounting device for solar modules in which two parallel tracks are provided with engagement devices. By means of a hinge connection, support elements can be disposed on the tracks in a way able to be folded down in the engagement devices by means of a hinge connection so that the support elements are able to be premounted on the tracks. Support elements of various lengths can thereby be used for different installation angles of the solar modules. The support elements can be folded down for transport, so that the tracks are stackable. The tracks are attached and the support elements set up on site. Then the solar modules are mounted thereon so that they can all be provided at the same installation angle. The mounting effort at the site foreseen for the solar modules is time-consuming owing to the separate mounting of tracks and modules. Furthermore, with the rigid tracks and the pre-selected support elements, differing shapes of a substrate can only be taken into account in a limited way.

### DESCRIPTION OF THE DRAWINGS

Preferred embodiments of the invention will be described in the following with reference to the drawings which serve merely for explanatory purposes and are not to be interpreted in a limiting way. Features of the invention disclosed from the drawings should be viewed individually and in every combination as belongs to disclosure of the invention.

FIG. 1 a diagrammatic three-dimensional view of a first embodiment variant of a module mounting according to the invention, with collector modules,

FIG. 2 a diagrammatic three-dimensional view of a further variant of the embodiment variant according to FIG. 1,

FIG. 3 a diagrammatic three-dimensional view of a second embodiment variant of a module mounting according to the invention, with collector modules,

FIG. 4 a diagrammatic three-dimensional view of a first version of a third embodiment variant of a module mounting according to the invention, with collector modules,

FIG. 4b a diagrammatic three-dimensional view of a second version of a third embodiment variant of a module mounting according to the invention

FIG. 5 a diagrammatic three-dimensional view of a fourth embodiment variant of a module mounting according to the invention, with collector modules,

FIG. 6 a diagrammatic two-dimensional view with a fifth embodiment variant of a module mounting according to the invention, with collector modules,

FIG. 7 a diagrammatic two-dimensional view of a detail of a module mounting according to FIG. 6,

FIG. 8a a diagrammatic side view of a module mounting according to the invention in folded state,

FIG. 8b a diagrammatic side view of the module mounting from FIG. 8a in unfolded state,

FIG. 8c a diagrammatic side view of the module mounting from FIG. 8a in completely unfolded state and

FIG. 9 a diagrammatic three-dimensional view of an unfolded module mounting according to the fifth embodiment variant.

### DETAILED DESCRIPTION

It is therefore an object of the present invention to provide a module mounting for a plurality of collector modules that makes possible a simple and quick alignment of the modules, which reduces the mounting effort at the mounting site, is easy to handle and makes possible a variable positioning of the modules.

This object is achieved by the invention by means of a module mounting according to claim 1 and a collector system according to claim 15. Advantageous embodiments and different embodiment examples are described in the dependent claims.

Provided according to the present invention is a foldable module mounting for arranging a plurality of collector modules in which the modules are able to be disposed in rows behind one another by unfolding of the module mounting. The module mounting is suitable in particular for collector modules in the form of photovoltaic modules or thermal solar modules. The module mounting according to the present invention has at least two, preferably several, support units each with at least two lateral supports which are able to receive at least one module between them. The support units can also be made up of more than two parallel lateral supports. The lateral supports of adjacent support units are connected together in an articulated way in a pivot plane. The lateral supports can thereby be connected by first hinges at their ends or at least their end regions. According to the invention at least one elongated connecting element is disposed in an articulated way on each lateral support. The connecting elements are provided as rigid rods, bars or struts. The connecting elements are attached to the lateral supports e.g. by means of second hinges and are pivotable in the same pivot plane as the lateral supports. In the case of at least one of two adjacent connecting elements the second hinge is thereby different from the first hinge. Two adjacent connecting elements of adjacent lateral supports are connected together in an articulated way such that the module mounting is foldable. The connecting elements are thereby also pivotable in the same pivot plane, e.g. by means of third hinges. The module mounting is foldable such that the lateral supports and connecting elements are situated close together in folded state, and are apart from one another in unfolded state. The module mounting has substantially a zigzag structure which can be stretched out or pushed together somewhat like an accordion. The lateral supports and connecting elements of the mounting module thus form a frame which can be clapped together on which a plurality of collector modules are able to be mounted in rows behind one another.

The collector modules can be attached already to the support units of the module mounting or can be attached only after an unfolding and fixing of the module mounting on the lateral supports. Also every second support unit can also thereby be provided without a collector module so that all modules are disposed at the same angle. A plurality of modules next to one another can also be attached to the lateral supports of a support unit. With a module mounting according to the present invention, collector modules can also be disposed advantageously on the lateral supports along more than half the length of the lateral support without the modules of adjacent support units overlapping vertically. Preferably collector modules are disposed along almost the entire length of the lateral supports.

The lateral supports can form a fixed support unit with at least one transverse beam attached between them. The transverse beams can also be attached directly to the modules. Instead of transverse beams the lateral supports can also be fixed relative to one another by means of one or more collector modules so that the support unit with the modules attached thereon is able to form a module unit. The module mounting is preferably transported in folded state, and is unfolded at a desired site, and is fixed or ballasted on a substrate. The collector modules are subsequently attached since the module mounting including the collector modules has a great weight, and is therefore difficult to handle. Since all the support parts necessary for the mounting are already connected together, it is not necessary to transport a lot of individual pieces and assemble them on site.

Preferably not just two but a multiplicity of support units are put in rows behind one another and are connected together in an articulated way, so that the support units form a kind of chain. The number of support units depends on the number of modules to be mounted and the conditions of the substrate. At least one first and second support unit is connected with connecting elements in each case. The second and a third support unit can also be provided without connecting elements while connecting elements are again provided between the third and a fourth support unit and so one. Thus in this case the third and the fourth support unit correspond to the first and to the second support unit. Alternatively a second support unit can also be provided as continuation of the installation chain, for example with four modules, without physical connection.

Provided in a way pivotable with respect to one another are adjacent lateral supports by means of the first hinges, connecting elements connected together by means of the third hinges and connecting elements connected to the lateral supports by means of the second hinges. The pivot axes of the hinges all run in the same pivot plane. Used as hinges can be e.g. conventional pin joints. Preferably one angle between adjacent lateral supports, between connecting elements connected in an articulated way and/or between one lateral support and one connecting element is provided in an adjustable way so that there can be a particular angular setting provided, e.g. by means of a rotation stop. There can also be different separate angular positions able to be selected by means of an adjustment and locking device. Thus a set angle for the collector module relative to the substrate, or respectively to the sun, can be predetermined. When setting up the module mounting, the latter can be simply pulled apart until the rotation stop or the locking device blocks.

With the foldable module mounting according to the invention the connecting elements disposed on each lateral support of a support unit and/or the connecting elements disposed on adjacent lateral supports are preferably symmetrical to one another. The connecting elements have e.g. the same length and/or the position of their pivot axes on the lateral support are at the same height. The at least two lateral supports of a support unit and also their connecting elements have preferably the same length. A plane of symmetry can run in longitudinal direction of the module row parallel between the lateral supports and connecting element. Another plane of symmetry can run through the first hinges of adjacent lateral supports or the third hinges of connected connecting elements. In this way e.g. two or three support units following each other can have a construction scheme or pattern which subsequently repeats itself until a desired number of collector modules are mounted on the module mounting.

In an embodiment variant of the module mounting according to the present invention, a parallelogram is formed by two lateral supports connected in an articulated way and the connecting elements provided thereon connected together with them. Alternatively the lateral supports and connecting elements connected together can form a triangle in which the connecting elements run along a straight line, i.e. the third hinge is completely stretched out. If the module mounting is mounted on a flat surface, it can be achieved through the configuration as parallelogram or triangle that the modules following one another each assume the same attachment angle. The parallelograms or triangles thereby repeat themselves identically in the respective construction pattern.

A length of a connecting element, which is connected to a connecting element of an adjacent lateral support, thereby corresponds substantially to a spacing between a pivot axis of the connecting element on the lateral support and a pivot axis of the connected lateral support. This means that the spacing between the first hinge, which connects the lateral supports, and the second hinge, with which the connection element is provided on the lateral support, corresponds to the spacing between the second hinge and the third hinge with which the connecting elements are connected. Alternatively the length of a connecting element can also be shorter than a spacing between a pivot axis of the connecting element on the lateral support and a pivot axis of the lateral supports so that a triangle can be formed when the connecting elements are stretched out into a straight line. Preferably connecting elements connected together each have the same length. Thus the same attachment angle relative to the substrate results for two adjacent support units, whereby however the angular positions are mirror-inverted with respect to the perpendiculars of the substrate. A construction pattern results for the module mounting with modules alternating at the same angle. Alternatively the connecting elements of adjacent support units can also have differing lengths. In this case the first, third, fifth, etc. collector module and the second, fourth, sixth, etc. collector module are each oriented at the same angle to the substrate, the angles thereby differing, however.

A symmetrical, alternating orientation of the collector modules with the same attachment angle makes sense e.g. with an installation of the module mounting in east-west direction in order to achieve an even exposure of all modules in the course of the whole day.

In another embodiment variant of the module mounting according to the invention, the connecting elements are provided on the lateral supports in a central region and can protrude with their ends from both sides of the lateral support. They are connected in an articulated way by a first end to a preceding connecting element of a preceding support unit and by a second end to a subsequent connecting element of a subsequent support unit. Lateral support and connecting element form substantially a crossed or respectively X-shaped connection, the arms of which are movable about the crossing point, i.e. the second hinge. Connecting elements and lateral supports are preferably of the same length. With a module mounting with a multiplicity of support units, the side supports following one after the other form a zigzag line, and the connecting elements following one after the other also form a zigzag line, the two zigzag lines crossing periodically. With this variant the connecting elements protrude on both sides beyond the lateral supports and all connecting elements are connected together at their ends in an articulated way. This gives the module mounting a robust construction.

In another embodiment variant of a module mounting according to the invention the connecting elements are disposed centrally on the lateral supports by one end and have a length corresponding substantially to half of the lateral supports. It can thereby suffice if in each case the connecting elements of a first and of a second support unit are connected together and the second and a third support unit have no connection by means of connecting elements. There can however also be connecting elements provided between the second and third support unit. With this construction, both in the folded as well as also in the unfolded state of the module mounting, the third hinge is located between the connecting elements and the first hinge between the lateral supports at the same height, and can therefore both serve for support and mounting on a substrate.

As mentioned, connecting elements can also be provided between a second and a third support unit. Preferably between the second and the third support unit connecting elements connected together in an articulated way are provided whose length is shorter than half of the lateral supports. A spacing between a pivot axis of the connecting element on the lateral support and a pivot axis of the lateral support preferably corresponds to the length of the connecting element. With this construction not only the first and second support units are arranged at a particular angle with respect to one another by means of connecting elements, such as e.g. described in the preceding variant, but also the second and third support units can be adjusted with respect to one another by means of shorter connecting element. The short connecting element protrudes not far upward however beyond collector modules mounted on the support units, and therefore casts little shadow that could interfere with the operation of the modules.

According to still another embodiment variant of the module mounting according to the present invention, disposed on a first support unit can be a first connecting element whose length corresponds to the length of a lateral support of a second support unit subsequent to the first support unit. A second connecting element, which is provided on the second support unit for connection to the first connecting element, can be formed by an extension of a lateral support of a third support unit, the third support unit following the second support unit. The extension and the lateral support are preferably designed as one piece. The second connecting element is thus composed of an end piece of the third lateral support. The second hinge, with which the extension is disposed on the second lateral support, corresponds in this variant to the first hinge with which the second lateral support is disposed on the third lateral support. The position of the hinge between the lateral supports of the second and third support unit thereby defines the length of the second connecting element. The second connecting element corresponds to the spacing between this hinge and the articulated connection of the first connecting element on the end of the third lateral support.

With this embodiment variant it is advantageous if no connecting elements have to protrude upwardly over the surfaces of the collector modules. The modules are thus not affected by shadows.

The individual collector modules are electrically connected in the usual way. For this purpose a cabling can be pre-installed e.g. along the lateral supports.

According to another aspect of the present invention, a collector module system is provided with a multiplicity of collector modules which are disposed on a module mounting, as described above, the collector module system being foldable. The system is suitable for all types of flat collector modules, in particular for photovoltaic modules and thermal solar modules.

The invention has been presented with reference to several embodiment variants. The individual technical features of an embodiment variant can certainly also be used in combination with another embodiment variant with the indicated advantages. The description of the technical features according to the invention is therefore not limited to the respective embodiment variants.

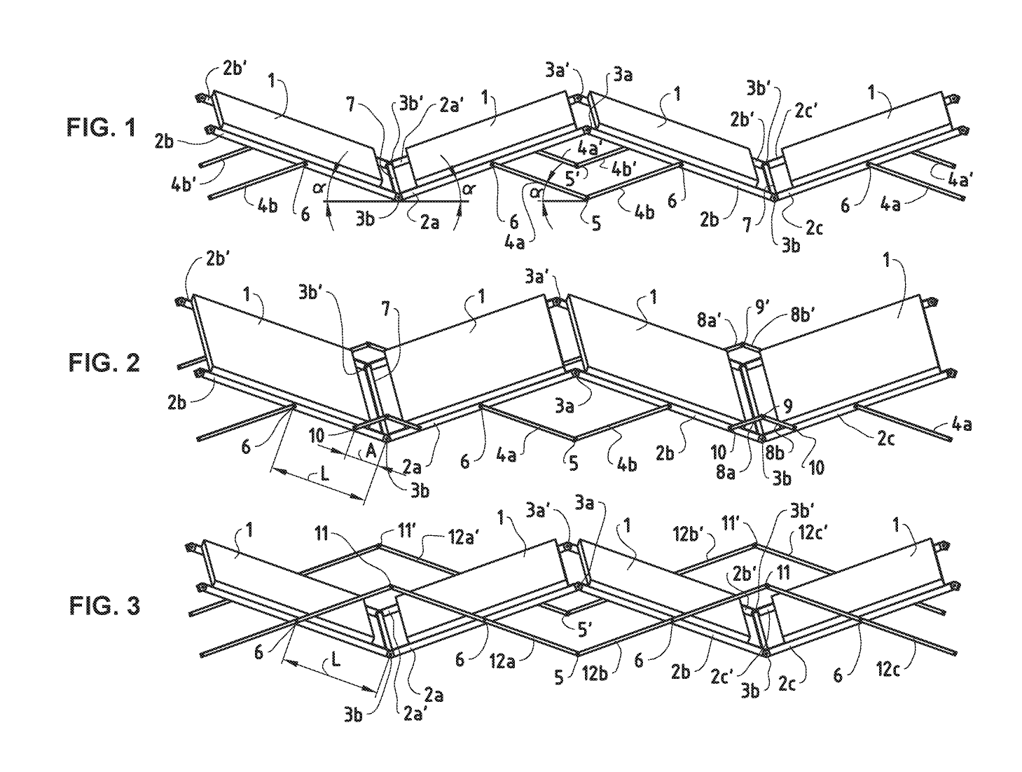

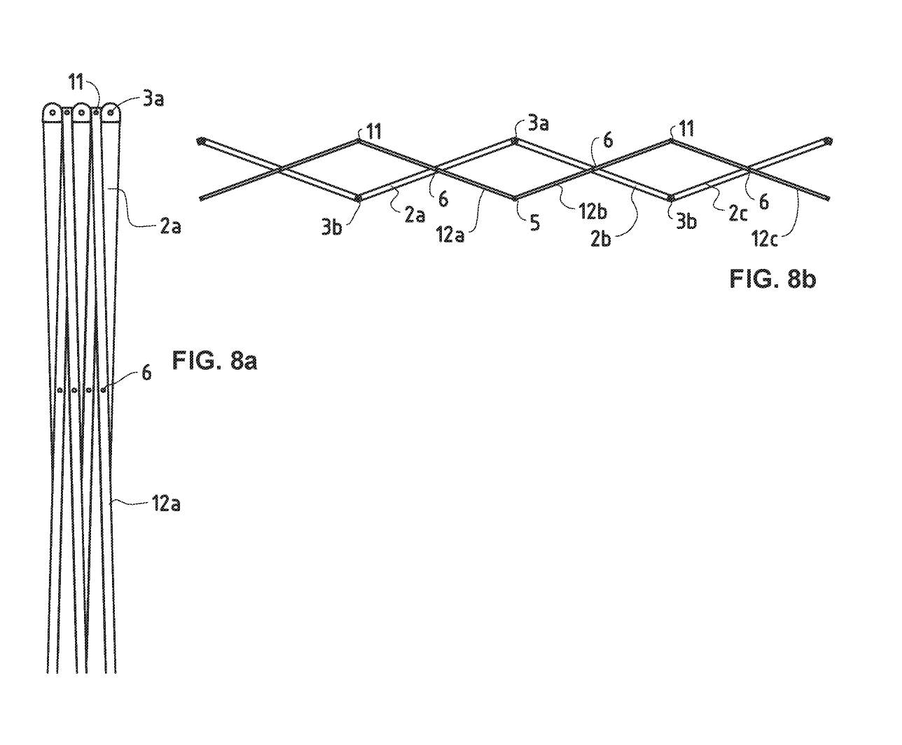

Shown in the figures will be different embodiment variants of module mountings and of collector module systems with such module mountings according to the invention. Shown by way of example in each case are four support units of a module mounting and correspondingly four collector modules. The module mountings can have however more than four support units and more than four collector modules, i.e. they can be longer than shown. The support units shown demonstrate the construction pattern of the respective embodiment variant. This pattern repeats itself periodically in the module mountings with more than four support units. The module mountings of FIGS. 1 to 6 are shown in unfolded state in order to show the construction pattern and the state in which they will be used for absorbing energy. All shown variants of module mountings can be folded together, as is shown in FIG. 8a. Elements of the different variants which are identical or have the same function have been given the same reference numerals to a large extent. Thus, for their description, the description of all variants should be referred to.

Shown in FIG. 1 is a first embodiment variant of a module mounting for collector modules 1 which has a first support unit with two lateral supports 2a and 2a′ disposed in parallel and a second support unit with two further lateral supports 2b and 2b′ disposed in parallel. The first and the second support unit demonstrate a first period of the construction scheme or pattern of the module mounting. The lateral supports of the support units are in each case connected together by transverse beams 7. The transverse beams 7 in the embodiment shown run directly between the lateral supports at the ends of the lateral supports, in particular along a hinge axis of the lateral supports, as presented more precisely below. Alternatively the transverse beams can also be disposed at other places, such as e.g. as border of the modules. The collector modules 1 are fixed in a usual way between the two lateral supports 2a and 2a′ running parallel and 2b and 2b′. For example the modules could be screwed onto a strip along the lateral support or could be pushed into a section shape. The adjacent lateral supports are connected by first hinges 3. The first hinges differ in such a way that the adjacent lateral supports 2a and 2b and 2a′ and 2b′ are connected together in an articulated way at their one end by first hinges 3a and 3a′ and at their other end by first hinges 3b and 3b′. For example, the lateral supports 2b and 2b′ are connected to adjacent lateral supports 2c and 2c′ by hinges 3b and 3b′. The lateral supports 2c and 2c′ belong to a support unit of a second period of the construction scheme or pattern which follows the first period. They thus correspond to the lateral supports 2a and 2a′. The reference numerals 2c and 2c′ are used for easier understanding of the construction scheme or pattern. The first hinges 3a and 3a′ are disposed upward in unfolded state of the module mounting, i.e. away from a substrate, while the first hinges 3b and 3b′ are disposed downward, i.e. on or at least near a substrate. The first hinges 3a and 3a′ enclose downwardly an angle of less than 180°, and the first hinges 3b and 3b′ enclose upwardly an angle of less than 180°, to achieve a desired angular setting of the modules. In principle the angles can also be 180°, i.e. the lateral supports can be unfolded completely into a line, if such an angular setting for the modules is desired. With folding together of the module mounting these angles will be reduced.

An elongated connecting element is disposed in an articulated way on each lateral support of the support units by means of a second hinge 6. Provided on the lateral support 2a is a connecting element 4a and on the lateral support 2b is a connecting element 4b. Correspondingly provided on the lateral support 2a′ is a connecting element 4a′ and on the lateral support 2b′ is a connecting element 4b′. In the variant shown, the connecting elements 4a, 4a′, 4b and 4b′ are disposed centrally with one end on their respective lateral support. Two adjacent connecting elements 4a and 4b, respectively 4a′ and 4b′, of adjacent lateral supports 2a and 2b, respectively 2a′ and 2b′, are connected in an articulated way at their ends by a third hinge 5, so that the module mounting is foldable. The pivot axes of the first hinges 3, second hinges 6 and third hinges 5 all lie in one plane.

In the variant shown, the length of the connecting elements 4a, 4a′, 4b and 4b′ corresponds substantially to the spacing of the second hinge and of the first hinge 3; in particular this length corresponds substantially to half the length of the lateral support 2a, 2a′, 2b and 2b′. The lateral support 2a and 2b, respectively 2a′ and 2b′, and the connecting elements 4a and 4b, respectively 4a′ and 4b′, form together a parallelogram. Owing to the dimensions of the lateral supports and of the connecting elements, the lower first hinges 3b, 3b′ and the third hinges 5, 5′ lie on a horizontal plane so that the module mounting can be supported on the ends of the lateral supports and of the connecting elements, which come out into the hinges. Rollers can be provided around the hinges 3 and 5, which rollers are used as an aid for installation purposes, for example. The rollers are preferably disposed in such a way that the module mounting can be rolled before fixing on the substrate.

In the variant shown in FIG. 1 following a second end of the lateral support 2a is a first end of the lateral support 2b of the adjacent support unit. In addition the lateral supports 2a and 2b are connected together via the connecting elements 4a and 4b. The connecting elements 4a and 4b are provided on a side of the module mounting facing downward in direction of the substrate. After the second end of the lateral support 2b follows a first end of a lateral support 2c of a subsequent support unit and is connected by means of a first hinge 3b. The connection of the first end of the lateral support 2c and of the second end of the lateral support 2b connects a further support unit to the first and second support units, and thus connects the periods of the construction scheme or pattern of the module mounting. The connection however has no connecting elements. Thus no connecting elements protrude from the support unit in upward direction which could cast a shadow on the collector modules 1.

Preferably provided on the upper first hinges 3a, 3a′ are rotation stops which limit an unfolding of the lateral supports, respectively of the support units, of the module mounting in the hinge 3. The lateral supports 2a, 2a′ and 2b, 2b′ have the same length. During unfolding of the module mounting until the rotation stop and placement of the module mounting on the first hinges 3 and the second hinges 5 on a flat horizontal substrate, the same installation angle α between underside of the lateral support 2a and 2b and the substrate thus results for the collector modules 1. Between the lateral supports 2a, 2b and the connecting elements 4a, 4b a parallelogram with doubled angle α is formed.

The variant shown in FIG. 1 can remain movable on the lower first hinges 3b, 3b′, i.e. between the adjacent support units without connecting elements so that during fixing of the module mounting on different substrates, differences in inclination or respectively changes in inclination can be taken into account in that the angle at the lower first hinges 3b, 3b′ may be selected freely.

Shown in FIG. 2 is another embodiment variant of a module mounting according to the invention, representing essentially an enhancement of the variant from FIG. 1. In additional to the connecting element 4a and 4b on a lower side of the module mounting described with reference to FIG. 1, connecting elements 8a, 8a′ and 8b, 8b′ are provided in an articulated way on an upper side of the module mounting. The connecting elements 8a, 8a′ and 8b, 8b′ are provided between a lateral support 2b, which follows with its second end via a lower hinge 3b to a first end of a lateral support 2c, and this lateral support 2c. The connecting elements 8a and 8b as well as 8a′ and 8b′ are connected together by fourth hinges 9 and 9′. Furthermore the connecting elements 8a, 8a′ and 8b, 8b′ are disposed on the lateral supports 2a, 2a′ and 2b, 2b′ by means of fifth hinges 10. The pivot axis of the first connecting elements 4a, 4a′ and 4b, 4b′ about the second hinges 6 has, with respect to the pivot axis of the first hinges 3, a distance apart L (likewise in the variant of FIG. 1, however not shown). As with FIG. 1, the connecting elements 4a, 4a′ and 4b, 4b′ are disposed centrally on the lateral supports. The pivot axis of the second connecting elements 8a, 8a′ and 8b, 8b′ about the fifth hinges 10 has, with respect to the pivot axis of the lower, first hinges 3b, a spacing apart A that is shorter than the spacing apart L. The spacing apart of the pivot axis of the fifth hinges 10 to the fourth hinges 9 corresponds substantially to the spacing A, so that once again a parallelogram is formed in unfolded state between the two connecting elements 8a, 8b and the lateral supports 2b, 2a. The second connecting elements 8a, 8a′ and 8b, 8b′ serve for fixing and guiding of the structure of the module mounting.

Shown in FIG. 3 is a second variant of a module mounting with collector modules 1 according to the invention. The construction of the lateral support 2a, 2a′ and 2b, 2b′ corresponds to that from the preceding variant. Disposed in an articulated way on the lateral supports are in each case connecting elements 12a, 12a′ and 12b, 12b′ by means of second hinges 6. The connecting elements 12a, 12a′ and 12b, 12b′ are disposed substantially midway on the lateral supports 2a, 2a′ and 2b, 2b′ and extend on both sides beyond the lateral support, i.e. both downwardly in direction of a substrate as well as upwardly away from the substrate. The connecting elements 12a, 12a′ and 12b, 12b′ are the same length on both sides of the lateral support, and have substantially the same length as the lateral supports. The downwardly protruding ends of the connecting elements 12a and 12b, respectively 12a′ and 12b′, are connected together by third hinges 5, 5′. The upwardly protruding end of the connecting elements 12b, 12b′ is connected to an upwardly protruding end of a connecting element 12c, 12c′ of an adjacent support unit by means of sixth hinges 11, 11′. Once again the connecting element 12c corresponds to the connecting element 12a, as explained previously. The length L between the pivot axes of the first hinges 3a or 3b and the second hinges 6 corresponds to the length between the pivot axes of the second hinges 6 and the third hinges 5 or the sixth hinges 11.

The lateral supports 2a and 2b form a first continuous zigzag line along the module mounting. The connecting elements 12a, 12b, 12c form in this variant a second continuous zigzag line along the module mounting. The zigzag lines are offset with respect to one another by half a period, i.e. in a mirror-inverted way along a horizontal plane. Once again the lateral supports and connecting elements in unfolded state form between them parallelograms and to be precise a lower parallelogram with the upper first hinges 3a, second hinges 6 and third hinges 5 and also an upper parallelogram with the lower first hinges 3b, second hinges 6 and sixth hinges 11.

Die connecting elements 12a, 12b correspond on the lower side to the connecting elements 4a, 4b of the first variant, but are extended symmetrically via the lateral supports 2a, 2b. The ends of the connecting elements and lateral supports on the lower first hinges 3b and the third hinges 5 again form supports for the module mounting. The additional upper connections with the sixth hinges 11, 11′ form a reinforcement for the structure of the module mounting.

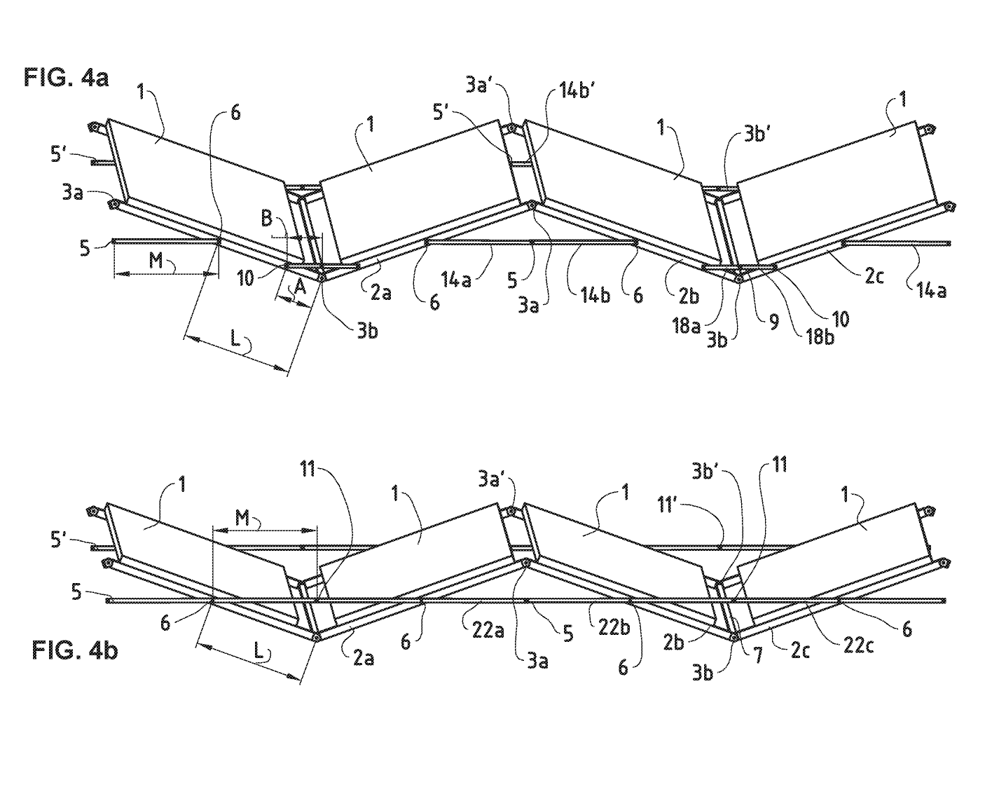

Shown in FIGS. 4a and 4b are two versions of a third embodiment variant of a module mounting according to the invention, in which in unfolded state no parallelogram is formed between lateral supports and connecting elements, but instead a triangle. In a folded state the connecting elements are angled with respect to one another. The construction of the lateral support 2a, 2a′ and 2b, 2b′ corresponds to that from the preceding variants.

Shown in FIG. 4a is a first version in which disposed in an articulated way on the lateral supports in each case are connecting elements 14a, 14a′ and 14b, 14b′ by means of second hinges 6. The connecting elements 14a, 14a′ and 14b, 14b′ are disposed substantially midway on the lateral supports 2a, 2a′ and 2b, 2b′. The ends of the connecting elements 14a, 14a′ and 14b, 14b′ are connected together through third hinges 5, 5′. Compared with the connecting elements 4a, 4a′ and 4b, 4b′, the connecting elements 14a, 14a′ and 14b, 14b′ are however shorter. This means that the length L between the pivot axes of the first hinges 3a, respectively 3b, and the pivot axes of the second hinges 6 along the lateral supports 2a, 2b is longer than a length M between the pivot axes of the second hinges 6 and the pivot axes of the third hinges 5 along the connecting elements 14a and 14b.

In unfolded state the lateral supports 2a, 2a′ and 2b, 2b′ should be stretched so far that the third hinges 5 enclose a 180° angle, and thus the connecting elements 14a and 14b, respectively 14a′ and 14b′, form a straight line. A triangle is thus formed between the lateral supports 2a and 2b and the straight line of the connecting elements 14a and 14b. Owing to the firm connecting of the connecting element on the lateral support and together a further stretching of the module mounting is not possible. Through the use of connecting elements of differing lengths, the length of the straight lines can be adjusted so that a maximal angle of opening between the lateral supports 2a and 2b on the first hinges 3a can be set.

In principle it is also possible not to unfold the module mounting so far until the connecting elements 14a and 14b form a straight line. In this case a rectangle is formed between the lateral supports 2a and 2b and the connecting elements 14a and 14b with a corner directed downward in direction of a substrate.

In the same way as the connecting elements 8a and 8b from the version shown in FIG. 2, in the case of the version from FIG. 4a connecting elements 18a and 18b can be used that are shorter than the connecting elements 8a and 8b. Hence a spacing A between a pivot axis of a lower third hinge 3b and a fifth hinge 10 along the lateral supports is greater than a spacing B between a pivot axis of a fifth hinge 10 and a fourth hinge 9 along the connecting elements 18a and 18b. In maximally opened state of the lower first hinges 3b, the connecting elements 18a and 18b are stretched into a straight line.

The length M and the spacing B are preferably coordinated with one another in such a way that in completely stretched state of the module mounting the straight lines of the connecting elements 14a and 14b and of the connecting elements 18a and 18b run parallel to one another and to a substrate. Thus all lower first hinges 3b of the support units of the module mounting can rest on the substrate. Advantageously with this embodiment variant according to FIG. 4a no elements of the module mounting protrude upwardly.

Shown in FIG. 4b is a second version which, summarized, represents a modification of the module mounting variant from FIG. 3 in combination with connecting elements according to the first version from FIG. 4a. Disposed in an articulated way on the lateral supports 2a, 2a′ and 2b, 2b′ in each case are connecting elements 22a, 22a′ and 22b, 22b′ by means of second hinges 6. The connecting elements 22a, 22a′ and 22b, 22b′ are disposed substantially midway on the lateral supports 2a, 2a′ and 2b, 2b′ and protrude on both sides in an equally long way beyond the lateral supports. Adjacent connecting elements 22a and 22b are connected in an articulated way, on the one hand by third hinges 5, 5′ and, on the other hand, by sixth hinges 11, 11′, as with the connecting elements 22b and 22c. The length of the connecting elements 22a and 22b is however shorter than in the case of the connecting elements 12a and 12b of the variant from FIG. 3, and corresponds to the spacing M, as previously described. The connecting elements 22a and 22b thus protrude on both sides of the lateral support with a length corresponding to the spacing M and are in each case connected to adjacent connecting elements through third hinges 5 and sixth hinges 11. In unfolded, completely stretched state of the module mounting the connecting elements 22a and 22b form a single line along the module mounting, which runs parallel to a substrate. In this state the module mounting can again be placed on the substrate with the ends of the lateral supports on the lower first hinges 3b, 3b′. The length of the connecting elements 22a and 22b is preferably the same, and is coordinated with a desired maximal angle of opening of the first hinges 3, by means of which the attachment angle of the collector modules 1 is also coordinated. Such a variant of a module mounting is very robust, and can be set up quickly without much effort being required for the angular setting of the modules.

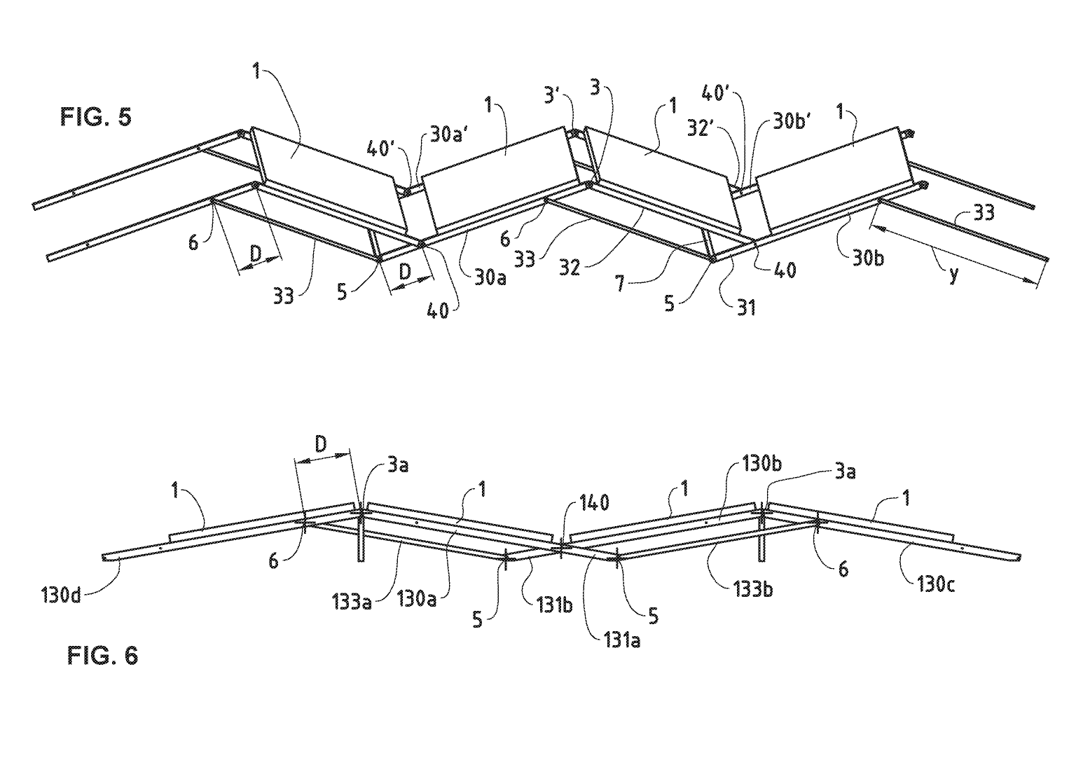

Shown in FIG. 5 is a fourth variant of a module mounting according to the invention, with collector modules. The variant is explained with reference to three consecutive support units, whereby a third support unit corresponds to a first support unit. The first support unit has first lateral supports 30a, 30a′. In a similar way the third support unit has first lateral support 30b, 30b′. A second support unit has second lateral supports 32, 32′. The first lateral support 30a, 30a′ and the second lateral supports 32, 32′ are connected through first hinges 3, 3′. The second lateral supports 32, 32′ are connected to the further first lateral supports 30b, 30b′ through seventh hinges 40, 40′. The seventh hinges 40, 40′ thus form hinges for articulated connection of lateral supports in the sense of the invention. On the first lateral supports 30a, 30a′, respectively 30b, 30b′, first connecting elements 33 are provided which are disposed on the lateral support on a first end by means of a second hinge 6. A length Y of the first connecting elements 33 corresponds to the length of the second lateral support 32. The first lateral supports 30a, respectively 30b, have an extension 31, which extends in longitudinal direction of the first lateral support. Preferably a first lateral support and its extension are designed in one piece as a single support. The length D of the extension 31 is determined by the position of the seventh hinge 40 away from the end of the lateral support. The extension 31 takes over the function of a second connecting element, which is disposed in an articulated way on the second lateral support 32. A second end of the connecting element 33 is disposed on the end of the extension 31 by means of a third hinge 5. The spacing between the first hinge 3, 3′ and the second hinge 6 corresponds to the length D. In this embodiment variant the first lateral support 30a, 30b together with the extension 31 is longer than the second lateral support 32.

In unfolded state the lateral supports 30a, 30b, the lateral support 32 and the connecting element 33 form a parallelogram. The module mounting rests on a substrate with the second ends of the connecting element 33 and the end of the extension 31 on third hinges 5 of the support units. Elements of the module mounting do not protrude over the collector modules 1, so that there is no risk of shadow cast on the modules. The module mounting has only a minimal number of components, so that it can be quickly pre-assembled.

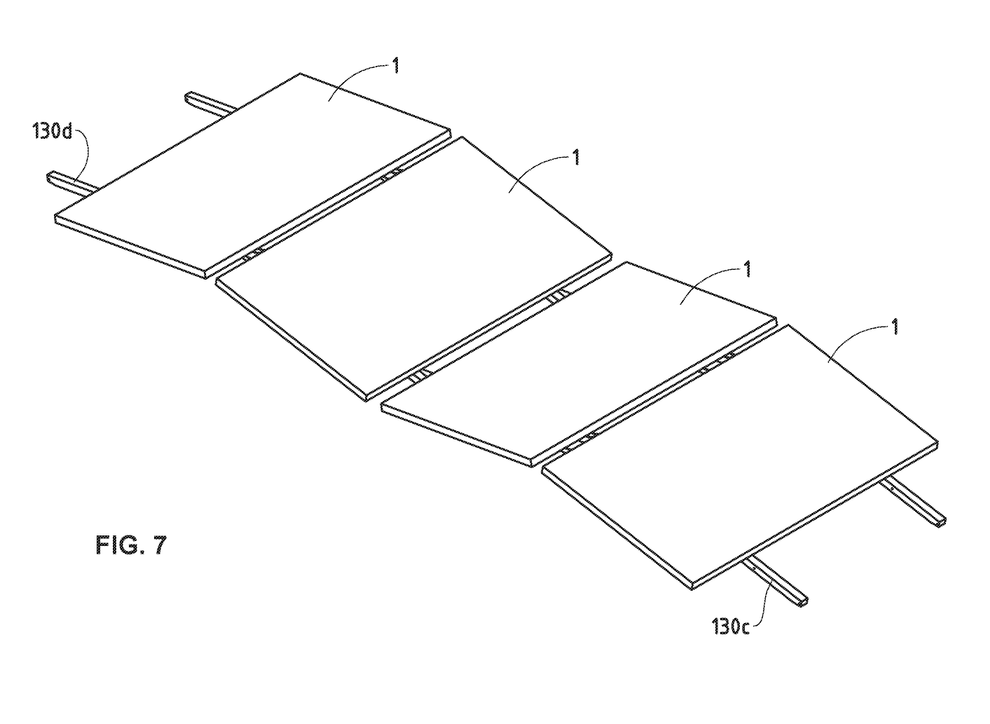

Shown in FIGS. 6 and 7 is a fifth variant of a module mounting according to the invention, with collector modules. In this variant four consecutive support units are connected together by means of connecting elements and form one period of the module mounting. Support units adjacent thereto are not connected by means of connecting elements, but instead are only coupled together through first hinges between the lateral supports. In this respect this variant is similar to the first variant from FIG. 1. In principle however these support units can also be provided with connecting elements. Used thereby can be connecting elements as described more precisely in the following or also connecting elements according to one of the previously described variants.

The four consecutive support units have in each case lateral supports 130a, 130b, 130c and 130d, and are connected together in an articulated way via upper first hinges 3a and lower first hinges 140. A further support unit adjacent to these four support units can likewise be connected by means of a hinge 140 or also by means of a lower first hinge, such as shown e.g. in FIG. 1. The lateral supports 130a and 130b have in the region of the first hinge 140 extensions 131a and 131b, which protrude beyond the pivot axis of the hinge 140. The extensions 131a and 131b form connecting elements comparable to the extension 31 from the variant according to FIG. 5. The extensions 131a and 131b are preferably designed in one piece with the lateral supports 130a and 130b. Furthermore provided are connecting elements 133a and 133b, which are coupled to the extensions 131a and 131b by one end through third hinges 5. The other end is coupled to a lateral support by means of second hinges 6. The connecting element 133a is thereby coupled to the extension 131b of the lateral support 130b and to the lateral support 130d which is situated in front of the lateral support 130a. The connecting element 133b is coupled to the extension 131a of the lateral support 130a and to the lateral support 130c which follows the lateral support 130b. The construction of the lateral support and of the connecting element in this variant is mirror-inverted with respect to a plane through the first hinge 140.

The arrangement of the connecting elements 133a and 133b on the lateral supports is comparable to that from FIG. 5. The spacing between the first hinge 3a and the second hinge 6 on the lateral supports corresponds again to a length D, which is coordinated with the extensions 131a and 131b. The hinge 140 serving as the first hinge for connection of adjacent lateral supports forms in this embodiment at the same time a second hinge for connection of lateral supports and connecting element in the form of extensions of the lateral supports. The third hinges 5 for connection of connecting elements connect the connecting elements 133a and 133b to the respective connecting elements in the form of extensions 131a and 131b.

FIG. 7 shows a three-dimensional view of an unfolded module mounting with mounted collector modules 1 according to a fifth variant, as shown in FIG. 6. As can be seen, in this variant no components of the module mounting protrude upwardly over the module, so they cannot cast any shadow on the module. Also no components are provided laterally on the module mounting which come to lie, in unfolded state, over the support plane of the lateral support. Thus the collector modules 1 can be installed between the lateral supports in such a way that on both sides of the module mounting they extend over the lateral supports. In this way the space requirement of the module mounting is reduced and the casting of a shadow on the modules prevented. Furthermore also with this variant of the module mounting collector modules can be mounted over almost the entire length of the lateral supports without the modules overlapping in vertical direction.

All embodiment variants shown of a module mounting according to the invention are symmetrical with respect to a center plane through the parallel-running lateral supports. Moreover the variants of FIGS. 1 to 4 are symmetrical to a perpendicular plane through the first hinges 3. With all embodiment variants the respectively described construction scheme or pattern repeats itself periodically. The number of the support units used in a module mounting is determined by the desired number of collector modules which are supposed to be installed on the module mounting.

The presented embodiment variants of the module mounting can have rotation stops on the first hinges 3, as mentioned above, or also on other hinges of the module mounting, which rotation stops limit an unfolding angle, i.e. an angle of opening of the module mounting. With the variants of FIGS. 4a and 4b such a stop is unnecessary, however. A rotation stop can be formed e.g. in that one end of a first lateral support 2a has a plate with a multiplicity of holes distributed about a circumference of the pivot axis. In a predetermined angular position a stop pin can be inserted in a hole corresponding to the position, and can serve as stop during unfolding of the module mounting. In a corresponding way such a plate with holes can be provided on one end of a connecting element.

In FIGS. 8a, 8b and 8c a module mounting without collector modules according to the embodiment variant of FIG. 3 is shown in a clapped-together state (FIG. 8a), in an unfolded state (FIG. 8b) and in a completely stretched state (FIG. 8c).

As FIG. 8a shows, the module mounting can be pushed together into a minimal volume. All upper first hinges 3a and all lower first hinges 3b come to lie next to one another. Since in this variant the connecting element 12a and 12b have the same length as the lateral supports 2a and 2b, the sixth hinges 11 come to lie between the upper first hinges 3a, and the third hinges 5 come to lie between the lower first hinges 3b. The second hinges 6 lie in the middle between the hinges 3a and 3b, respectively the hinges 5 and 11. It can be seen in FIG. 8b that the lateral supports 2a and 2b with the connecting elements 12a and 12b form parallelograms. The lower ends of the lateral supports 2a and 2b and the lower ends of the connecting elements 12a and 12b come out into the lower first hinges 3b and the third hinges 5, whereby the lower first hinges 3b and the third hinges 5 lie on a line. In FIG. 8c the module mounting is completely unfolded so that the third hinges 5 and the sixth hinges 11 enclose an angle of 180°, and the connecting elements 12a, 12b and 12c form a line. Likewise the lateral supports 2a, 2b and 2c are completely stretched out and form a straight line. The straight lines of the lateral supports and of the connecting elements run parallel, whereby on an outer side of the lateral supports the connecting elements rest on these lateral supports. A complete unfolding is also possible with the embodiment variants of the module mounting from FIGS. 1, 2 and 5.

### CLOSING COMMENTS

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

### REFERENCE SIGNS

| | |
|---|---|
| 1 | collector module |
| 2a, 2a′ | lateral support |
| 2b, 2b′ | lateral support |
| 3 | first hinge |
| 3a, 3a′ | upper first hinge |
| 3b, 3b′ | lower first hinge |
| 4a, 4a′ | first connecting element |
| 4b, 4b′ | second connecting element |
| 5, 5′ | third hinge |
| 6, 6′ | second hinge |
| 7 | transverse beam |
| 8a, 8a′ | first connecting element |
| 8b, 8b′ | second connecting element |
| 9, 9′ | fourth hinge |
| 10, 10′ | fifth hinge |
| 11, 11′ | sixth hinge |
| 12a, 12a′ | connecting element |
| 12b, 12b′ | connecting element |
| 14a, 14a′ | connecting element |
| 14b, 14b′ | connecting element |
| 30 | lateral support |
| 31 | extension |
| 32 | lateral support |
| 33 | connecting element |
| 40 | seventh hinge |
| 130a-d | lateral support |
| 131a, 131b | extension |
| 133a, 133b | connecting element |
| α | attachment angle |
| A | spacing |
| D | length extension |
| L | spacing |
| M | length |
| Y | length connecting element 33 |

1. A module mounting for disposing a plurality of collector modules (1) behind one another, the module mounting comprising:
at least two support units each with at least two lateral supports, the lateral supports configured to receive between them at least one collector module and the lateral supports of adjacent support units being connected together in an articulated way by first hinges (3; 40; 140), wherein at each lateral support is at least one elongated connecting element in an articulated way, at least one of two adjacent connecting elements connected by second hinges, which differ from the first hinges, and two adjacent connecting elements of adjacent lateral supports being connected together in an articulated way by third hinges so that the module mounting is foldable.

2. The module mounting according to claim 1, wherein the second hinges between the adjacent lateral supports and connecting elements have a spacing to the first hinges.

3. The module mounting of claim 1, wherein an angle between adjacent lateral supports, between the connecting elements connected in an articulated way and/or between one of the lateral supports and one of the connecting elements is adjustable.

4. The module mounting of claim 1 wherein the connecting elements each disposed on the lateral support of the support unit and/or the connecting elements disposed on adjacent lateral supports are symmetrical to one another with respect to their length and/or their pivot axis on the lateral support.

5. The module mounting of claim 1 wherein a parallelogram or triangle is formed by two lateral supports connected together in an articulated way and by the connecting elements connected to these lateral supports and provided on these connecting elements.

6. The module mounting of claim 1 wherein the connecting elements are disposed in a region between the ends of one of the lateral supports.

7. The module mounting of claim 1 wherein a length of a connecting element is shorter than a spacing between a pivot axis of a second hinge of the connecting element on the lateral support and a pivot axis of a first hinge of the lateral support.

8. The module mounting of claim 1 wherein in an unfolded state of the mounting module the connecting elements are aligned in one line and in a folded state are at an angle to one another.

9. The module mounting of claim 1 wherein the connecting elements are provided on the lateral supports in a central region and are connected in an articulated way with a first end on a preceding connecting element of a preceding support unit and with a second end on a subsequent connecting element of a subsequent support unit.

10. The module mounting of claim 1 wherein one end of the connecting elements is centrally disposed on the lateral support and the connecting elements have a length corresponding to half of the lateral support, the connecting elements of a first and of a second support unit being connected together in each case.

11. The module mounting of claim 1 wherein the connecting elements connected together in an articulated way by third hinges are provided between two support units the length of connecting elements is shorter than half of the lateral supports of the support units.

12. The module mounting of claim 1 wherein provided as support on a substrate is a first hinge between the lateral supports and/or a third hinge between the connecting elements.

13. The module mounting of claim 1 wherein on a first lateral support of a first support unit a first connecting element is provided in an articulated way, via a second hinge, whose length corresponds to the length of a second lateral support of a second support unit connected to the first support unit, and
a second connecting element, which is provided on the second support unit for connection to the first connecting element, is formed through an extension of a third lateral support of a third support unit, which is subsequent to the second support unit.

14. The module mounting of claim 1 wherein the collector modules are disposed on the lateral supports over half the length of the lateral supports, without collector modules of adjacent support units overlapping vertically.

15. The module mounting of claim 1 wherein one end of a lateral support or of a connecting element has a plate with a plurality of holes distributed on a circumference of the pivot axis, one stop pin being insertable in a hole corresponding to a predetermined angular position of the first or second hinge.

16. A collector module system with a plurality of collector modules disposed in rows mounted on a module mounting of claim 1, wherein the collector module system is foldable.
